(19) United States
(12) Patent Application Publication
(10) Pub. No.: US 2023/0294482 A1
(43) Pub. Date: Sep. 21, 2023

(54) APPARATUS FOR THE DIRECTED DISCHARGING OF DROPLETS AND/OR PARTICLES, IN PARTICULAR IN THE INTERIOR OF A MOTOR VEHICLE, MOTOR VEHICLE AND METHOD FOR OPERATING AN APPARATUS OF THIS KIND

(71) Applicant: DAIMLER AG, Stuttgart (DE)

(72) Inventors: Joachim CURRLE, Stuttgart (DE); Johannes BRAIG, Stuttgart (DE)

(21) Appl. No.: 18/023,033

(22) PCT Filed: Jul. 23, 2021
(86) PCT No.: PCT/EP2021/070700

§ 371 Date: Feb. 24, 2023

(30) Foreign Application Priority Data
Aug. 25, 2020 (DE) 10 2020 005 186.3

(51) Int. Cl. B60H 1/24

(52) U.S. Cl. CPC B60H 1/248; B60H 1/246

(57) ABSTRACT

A device for removing particulates includes an outflow opening and a fan that delivers air through the outflow opening. An air curtain is formed in front of a mouth and nose region of a person by the air delivered by the fan and which is directed in a targeted manner to remove particulates. The device has a collection element with at least one capture opening opposite the outflow opening. A least part of the air curtain, which runs in a plane stretched through transverse and vertical directions of a motor vehicle, is captured by the capture opening to remove at least a part of the particulate.

### BACKGROUND AND SUMMARY OF THE INVENTION

Exemplary embodiments are directed to a device for removing droplets and/or particles in a targeted manner, particularly in the interior of a motor vehicle, motor vehicle and method for operating a device of this kind.

WO 03/086125 A1 discloses a device for generating an air curtain over a face of a person. The device is a head-mounted unit that can be fixed on the head of the person. A system for controlling introduction or removal of breathing air can be taken as known from DE 92 09 893 U1. DE 600 35 042 T2 additionally discloses a face mask.

Exemplary embodiments of the present invention are directed to a device for removing droplets and/or particles in a targeted manner, particularly in the interior of a motor vehicle, a motor vehicle and a method, such that droplets or particles can be particularly advantageously removed.

A first aspect of the invention relates to a device for removing droplets and/or particles in a targeted manner. The droplets or particles can particularly be understood as droplets or particles that have a diameter of more than five micrometers. The particles or droplets can further be understood as particles or droplets that have a diameter of less than five micrometers, and are thus employed in aerosols, for example. As is well known, an aerosol is a heterogeneous mixture comprising suspended solid particulates and/or suspended liquid particulates and a gas, in which the floating particulates, particularly distributed, are received or arranged. The droplets or particles are thus the suspended liquid or solid particulates, for example. The device has at least one outflow opening and at least one fan that can preferably be operated electrically. Air can be delivered through the outflow opening by means of the fan, whereby an air curtain, which is formed in front of a mouth and nose region of a person by the air delivered by means of the fan, and particularly formed by air delivered through the outflow opening, and which is directed in a targeted manner can be provided for removing the droplets, particularly from the mouth and nose region and/or from a region arranged in front of the mouth and nose region of the person. In other words, the air curtain that is formed by the air delivered by means of the fan can be provided directed in a targeted manner by means of the device, as the air is delivered, and thus delivered through the outflow opening by means of the fan of the device in such a way that the air curtain is directed to or into the mouth and nose region in a targeted manner and/or is aligned in a targeted manner relative to the mouth and nose region in such a way that the air curtain streams past in front of the mouth and nose region, and thus in front of the mouth and nose of the person, particularly in such a manner that the air forming the air curtain touches the mouth and the nose or, contrastingly, is spaced apart from the mouth and nose. The air curtain can thus remove droplets and/or particles from the mouth and nose region and/or from the previously specified region arranged in front of the mouth and nose region, such that, for example, the air curtain can prevent droplets and/or particles from being able to reach or enter the mouth and nose region, and thus from being able to reach the nose and the mouth and enter the nose and the mouth.

In order to be able to remove the droplets or particles from the mouth and nose region and/or from the region arranged in front of the latter particularly advantageously, and thus for example to stop or keep the droplets or particles away from the mouth and the nose of the person particularly effectively and efficiently, it is provided according to the invention that the device has at least one collection element having at least one capture opening opposite the outflow opening, by means of which capture opening at least a part of the air curtain, and thus at least a part of the droplets and/or particles removed by means of the air curtain and delivered to the capture opening in a targeted manner can be captured in a targeted manner. This should particularly be understood to mean that at least the part of the air curtain, and thus at least the part of the droplets or the particles flows through the capture opening and can thus flow over the capture opening into the collection element. The particles or the droplets thus do not remain in the interior uncontrollably, and thus cannot get back to the person again or reach another person, and instead the droplets or particles can be removed in a targeted manner, and thus be kept away from a person and also from other people, for example. An infection risk can thus be kept particularly low.

The invention is particularly based on the following knowledge: Many illnesses can be transmitted by respiratory droplet infection, e.g., the novel corona virus. Pathogens carried by means of the droplets can be found both in droplets having a diameter of more than five micrometers and in droplets of aerosols, whose droplets generally have a diameter of less than five micrometers. According to the latest findings, droplets having a diameter of more than five micrometers and droplets of aerosols, and thus having a diameter of less than five micrometers, lead to infections in approximately equal proportions. The droplets and the particles are also described in summary as particulates in the following, wherein large particulates are particularly understood as droplets or particles that have a diameter of more than five micrometers, and small particulates are particularly understood as droplets or particles that have a diameter of less than five micrometers. While large particulates sink in the downward vertical direction relatively quickly due to their own weight, and thus drop downwards relatively quickly, the small particulates remain in the air for a very long time. The small particulates have a substantially lower mass than the large particulates, and can move in a space, e.g., in an interior of a motor vehicle with air flows present in the space. Particularly in an interior of a motor vehicle, air flows can flow at far higher air speeds in comparison with a closed space in a building, whereby the particulates can be quickly distributed in the entire interior.

A motor vehicle usually has at least one air outflow device, also known as an air nozzle, via which air is delivered to the interior in order to ventilate the interior. The air outflow device is flowed through by air in this case, which forms an air flow, which is also described as an open air jet. The open air jet particularly has a high speed or flow speed in the region of the air outflow device, which can lead to a significant acceleration of particulates expelled with breathing air of a person, for example, and can thus drive pathogens. Filter systems of motor vehicles, particularly of air conditioners of motor vehicles, can filter particulates in introduced or delivered air, particularly fresh air or circulating air, wherein these filter systems usually only have degrees of separation that do not or only insufficiently filter microparticles or the previously described small particulates from the air, i.e., are able to separate them from the air. Regardless of target degrees of separation for small particulates or microparticles, it is disadvantageous that particulates that are expelled with breathing air leave the interior via ventilation or are removed from the interior and delivered to a filter with an air circulation only after remaining in the interior for a relatively long period. Against this background, the invention now enables the particulates to be directed via a forced flow in the direction of the capture opening, and to be removed via the capture opening at their place of creation or release, i.e., in the region of the nose and the mouth of the person who is a passenger remaining in the interior of the motor vehicle, for example. The previously specified forced flow is the air curtain or the air forming the air flow and thus particularly flowing from the outflow opening to the capture opening, which removes the particulates from the mouth and nose region and/or from the region arranged in front of the latter, directs said particulates to the intake opening, and particularly through the capture opening, and thus delivers them into the collection element also described as a capture element.

The outflow opening is arranged in an outflow surface, for example, or is also described as an outflow surface, on which or via which the device can provide the air delivered by means of the fan. The capture opening is also described as a collection opening, for example, and is arranged on or in a collection surface, via which the collection element (capture element) can capture and particularly receive at least the part of the air curtain, and thus at least the part of the particulates. The collection surface or the capture opening can be part of a vehicle interior boundary, i.e., be formed for example in a vehicle interior boundary. The vehicle interior boundary is particularly understood as an internal cladding element by means of which the interior of the motor vehicle preferably formed as a motor car, particularly as a passenger car, is at least partially, particularly directly, delimited or bounded. The particulates are transported to the collecting surface or to the capture opening and removed there and separated by the forced flow, for example. The dispersed particulates cannot get back to the person and also cannot reach another person possibly remaining in the vehicle interior, such that an infection risk, particularly during a journey of the motor vehicle, can be kept within a particularly low range.

The outflow opening is preferably overlapped at least partially, particularly at least largely or entirely by the capture opening in the flow direction of the air curtain flowing to the collection element or the capture opening, whereby the particulates can be captured or collected particularly well.

In an advantageous embodiment of the invention, it is provided that the collection element has a further fan provided in addition to the fan to be able to remove the particulates particularly effectively and efficiently, wherein the previous and following embodiments of the first fan can also be easily applied to the further fan and vice versa. When the fan is mentioned in the following, this is to be understood as the first fan, unless stated to the contrary. At least the part of the air curtain, and thus at least the part of the droplets and/or particles (particulates) removed by means of the air curtain and delivered to the capture opening in a targeted manner can be taken into the intake opening by means of the further fan. In other words, air can be taken in, and thus delivered by means of the further fan. Air can particularly be introduced from an environment of the collection element by means of the further fan, and thus delivered through the capture opening, and thus be taken into the collection element (capture element), such that at least the part of the air curtain, and thus at least the part of the particulates can be taken from the environment of the capture opening into the capture opening, and thus taken through the capture opening by means of the further fan.

In a further embodiment the collection element has a filter element for filtering at least the part of the air curtain captured by means of the capture opening. The part of the air curtain is described as an air curtain part in the following. At least the air curtain part that flows through the capture opening, and thus flows into the collection element and is thus captured can thus flow through the filter element and be filtered by means of the filter element, whereby the particulates can be particularly advantageously kept away from people.

It has here proved particularly advantageous if the filter element is formed for the purpose of retaining droplets and/or particles having a diameter of less than five micrometers, and thus to filter said droplets and/or particles out of the captured part of the air curtain. It can here be safely and effectively avoided that the possibly infectious particulates reach the person or another person, such that the infection risk can be kept within a particularly low range.

It has here proved particularly advantageous if the filter element is particularly arranged downstream of the further fan in the flow direction of the air curtain part taken into the collection element via the capture opening by means of the further fan and thus delivered. A safe filtration of the air curtain part or the air formed by the air curtain part can thus be guaranteed.

In order to be able to remove the particulates in a particularly targeted and safe manner, it is provided in a further embodiment of the invention that the capture opening is formed or delimited by a conduit element particularly formed as a solid body. It has here proved particularly advantageous if the device has at least one or several air guidance elements. The air guidance element can be moved, particularly pivoted, relative to the conduit element, whereby a flow direction of the air flowing through the outflow opening, i.e., delivered by means of the fan and forming the air curtain can be varied, i.e., can be adjusted by means of the air guidance element. The air guidance element is preferably inherently rigid or dimensionally stable in form. The air guidance element can particularly be formed as an inherently rigid or dimensionally stable disc that has a longitudinal extension direction, for example. The longitudinal extension direction of the disc runs perpendicular to the flow direction of the air delivered by means of the first fan, for example.

In a further embodiment the outflow opening and the capture opening are arranged in the interior of a motor vehicle. The motor vehicle can thus be a component of the device. This embodiment is particularly based on the knowledge that particularly interiors of motor vehicles, particularly of motor cars, are small in comparison with large spaces of buildings and can in particular be self-contained spaces in which possibly infectious particulates can spread quickly if no corresponding countermeasures are taken. Such unimpeded and rapid spreading of possibly infectious particulates, for example expelled from a person, can now be effectively and efficiently avoided via the invention, such that the infection risk in the interior of the motor vehicle preferably formed as a motor car, particularly as a passenger car, can be kept within a particularly low range.

In a further embodiment of the invention the outflow opening and/or the capture opening, particularly a channel element bordering the outflow opening or the capture opening, particularly directly, is arranged on a seat arrangement arranged in the interior of the motor vehicle or on an internal cladding element delimiting the interior, particularly directly, particularly on a roof liner of the motor vehicle at least partially delimiting the interior upwards in the vertical direction of the vehicle, particularly directly, in order to be able to arrange the outflow opening and/or the capture opening in particularly close proximity of the mouth and nose region of the person, and thus to be able to remove the particulates in a targeted manner. The previously specified channel element delimiting the outflow opening, particularly directly, can be the conduit element previously named, for example.

In a further embodiment the device is a constructed unit in itself, which in itself can be releasably reversibly fixed on the head of the person. The person can thus wear the device in the state fixed on the head of the person, and carry it with them, such that particulates can both then be removed if the person is in the interior of the motor vehicle, and also when the person is outside of the interior of the motor vehicle, and is walking around, for example. The infection risk can thus also be kept particularly low in spaces other than the interior of the motor vehicle.

A second aspect of the invention relates to a motor vehicle preferably formed as a motor car, particularly as a passenger car, having at least one seat arranged in the interior of the motor vehicle for a person described as a passenger of the motor vehicle. This means that the person can sit on the seat and thus remain in the interior, particularly during a journey of the motor vehicle. The seat is formed by a seat arrangement arranged in the interior, for example, which can be a bench seat or an individual seat.

In order to remove droplets and/or particles particularly effectively and efficiently here, and thus to be able to keep the infection risk in the interior of the motor vehicle particularly low, it is provided in the second aspect of the invention that the motor vehicle comprises at least one device for removing droplets and/or particles (particulates) in a targeted manner. The device has at least one outflow opening arranged in the interior of the motor vehicle, i.e., leading into the interior, and at least one fan by means of which air can be delivered through the outflow opening. The device can thus provide an air curtain that is formed in front of a mouth and nose region of the person sitting in the seat by the air delivered by means of the fan and is directed in a targeted manner, by means of which air curtain droplets and/or particles, particularly from the mouth and nose region and/or from a region arranged in front of the mouth and nose region can be removed. The particles and/or droplets also described in summary as particulates can thus be kept away from the mouth and nose of the person or be removed in a targeted manner, such that other people optionally remaining in the interior cannot be infected by the particulates expelled by the first person, for example. Advantages and advantageous embodiments of the first aspect of the invention should be seen as advantages and advantageous embodiments of the second aspect of the invention and vice versa.

A third aspect of the invention relates to a method for operating a device according to the first aspect of the invention and/or for operating a motor vehicle according to the second aspect of the invention. The method thus particularly comprises air being delivered by means of the fan, which air flows through the outflow opening such that the device provides an air curtain for removing droplets and/or particles, the air curtain being formed in front of the mouth and nose region of a person by the air delivered by means of the fan and is directed in a targeted manner. The air curtain or its flow direction runs in a plane, for example, which is stretched through the transverse direction of the vehicle and the vertical direction of the vehicle. The air curtain or its flow direction runs in the transverse direction of the vehicle, for example, obliquely to the transverse direction of the vehicle or in the vertical direction of the vehicle, particularly from bottom to top.

Further advantages, features and details of the invention result from the following description of preferred exemplary embodiments and with reference to the drawing. The features and combinations of features previously specified in the description and the features and combinations of features specified in the following description of figures and/or shown only in the figures can be used not only in the respectively disclosed combination, but also in other combinations or in isolation without leaving the scope of the invention.

### BRIEF DESCRIPTION OF THE DRAWING FIGURES

In the drawing:

FIG. 1 shows a schematic perspective view of a first embodiment of a device according to the invention for removing droplets and/or particles in a targeted manner;

FIG. 2 shows a schematic perspective view of the device according to a second embodiment, wherein a conduit element of the device is in a usage position;

FIG. 3 shows a schematic perspective view of the device according to the second embodiment, wherein the conduit element is in a stowed position;

FIG. 4 shows a schematic perspective view of the device according to a third embodiment, wherein the conduit elements of the device are in a usage position;

FIG. 5 shows a schematic perspective view of the device according to the third embodiment, wherein the conduit elements are in a stowed position;

FIG. 6 shows a schematic perspective view of a fourth embodiment of the device;

FIG. 7 shows a schematic and cross-sectional side view of the device according to a fifth embodiment;

FIG. 8 shows a schematic cross-sectional view of the device according to the fifth embodiment along a cut line A-A shown in FIG. 7; and

FIG. 9 shows a section of a schematic and cross-sectional side view of the device according to a sixth embodiment.

Identical elements or elements having identical functions are labelled with the same reference numerals in the figures.

### DETAILED DESCRIPTION

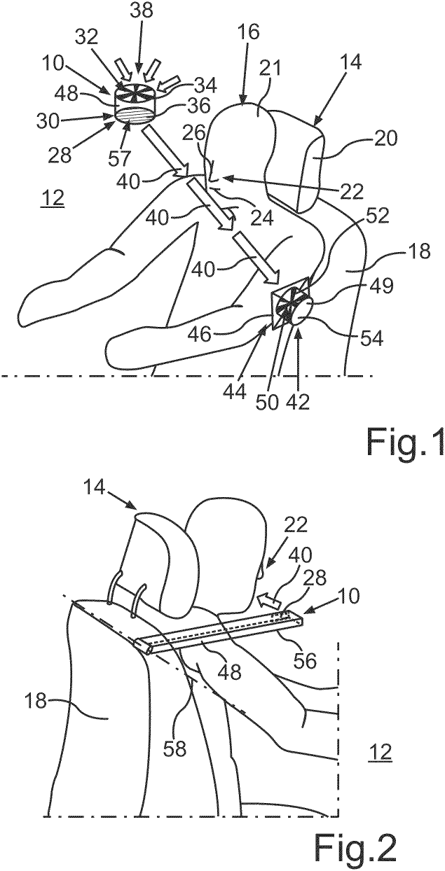

FIG. 1 shows a first embodiment of a device 10 for removing droplets and/or particles in a targeted manner in a schematic perspective view. The droplets and the particles are also described in summary as particulates in the following, such that when particulates are mentioned in the following, the droplets and/or the particles should be understood as meant. A section of an interior 12 of a motor vehicle preferably formed as a motor car, particularly as a passenger car, can particularly be seen in FIG. 1, wherein the device 10 can comprise the motor vehicle or vice versa, such that at least a part of the device 10 can be arranged in the interior of the motor vehicle. It can be seen from FIG. 1 that a seat arrangement 14 presently formed as a single seat is arranged in the interior 12 of the motor vehicle, which seat arrangement provides at least or exactly one seat for a person 16 also described as a passenger. The person 16 sits on the seat, and thus on the seat arrangement 14. The seat arrangement 14 has a back rest 18, against which the person 16 can lean their back. The seat arrangement 14 additionally comprises a head rest 20 against which the person 16 can lean their head 21. A mouth and nose region 22 of the person 16 can additionally be seen in FIG. 1, in which mouth and nose region 22 the mouth 24 and the nose 26 of the person 16 are arranged.

The person 16 can breathe through their nose 26 and through their mouth 24, particularly breathe in and out, such that the person 16 can breathe out and thus expel droplets and/or particles, i.e., particulates, via their nose 26 and via their mouth 24. The droplets and the particles can form an aerosol with the air arranged in the interior 12, for example, in such a way that the particulates are distributed in the air. As explained in more detail in the following, it can be avoided by means of the device 10 that the particulates are able to be distributed in the entire interior 12 excessively quickly. For this purpose, the device 10 comprises at least one outflow opening 28, which is arranged or formed on or in an outflow surface 30, for example. The device 10 further comprises a fan 32, also described as an assistance fan, that is particularly provided in addition to a main fan, provided for ventilating the interior 12, of a ventilation device, particularly an air conditioner, of the motor vehicle. The fan 32 comprises a fan wheel 34 that can be rotated relative to a housing 36 of the fan 32, for example. Air is delivered by means of the fan 32 by rotating the fan wheel 34, and particularly delivered through the outflow opening 28. The fan 32 can preferably be operated electrically. By this should particularly be understood that the fan 32 has an electric motor that cannot be seen in FIG. 1, by means of which the fan wheel 34 can be driven by using electrical energy and can thus be rotated relative to the housing 36. By rotating the fan wheel 34, the fan 32 takes in air, particularly from the interior 12, which is depicted by arrows 38 in FIG. 1. The air first taken in by means of the fan 32 and then thus delivered is delivered through the outflow opening 28, and delivered away from the fan 32 in such a manner that an air curtain depicted in FIG. 1 by arrows 40 for removing droplets and/or particles, particularly from the mouth and nose region 22 and/or from a region arranged in front of the mouth and nose region 22, which is formed in front of the mouth and nose region 22 of the person 16 by the air delivered by means of the fan 32 and is directed in a targeted manner, can be or is provided by means of the device 10. The arrows 40 particularly depict a flow direction in which the air curtain or the air forming the air curtain flows. It can particularly be seen from FIG. 1 here that the air curtain or its flow direction runs in a plane formed by the transverse direction of the vehicle (y direction) and the vertical direction of the vehicle (z direction), and runs in parallel or obliquely to the transverse direction of the vehicle here, for example. It is particularly provided that the outflow opening 28 is arranged in the vertical direction of the vehicle in such a manner that the outflow opening 28 is arranged at least substantially at the height of the mouth 24 and/or the nose 26. The outflow opening 28 is additionally arranged in close proximity to the mouth and nose region 22, and thus not too far from the nose 26 and the mouth 24. The outflow opening 28 or the outflow surface 30 can be arranged on a roof region of the motor vehicle, for example, wherein the interior 12 is at least partially, particularly at least predominantly or completely delimited by the roof region in the upward vertical direction of the vehicle.

To be able to remove the particulates (droplets and/or particles) effectively and efficiently, and thus to be able to effectively and efficiently avoid an excessively fast distribution of the particulates in the interior 12, the device 10 has at least one collection element 42 having at least one or several capture openings 44 opposite the outflow opening 28, which is arranged on or in a collection surface 46, for example. The collection surface 46 runs in a plane that is stretched between the longitudinal direction of the vehicle (x direction) and the vertical direction of the vehicle (z direction), for example. It can be seen with reference to the arrows 40 that the air curtain or the air forming the air curtain is a forced flow that runs at least substantially in the transverse direction of the vehicle, particularly outwards, and here particularly runs to the capture opening 44. This forced flow is generated by the fan 32, which — as is shown by the arrows 38 — takes in air in the immediate vicinity of the outflow opening 28 and delivers it through an air channel 48 simply described as a channel, and thus delivers it to the outflow opening 28 via the air channel 48, and consequently delivers it through the outflow opening 28. The air channel 48 particularly has the outflow opening 28, via which the air delivered by means of the fan 32 and delivered through the air channel 48 can flow out of the air channel 48. The air channel 48 and the outflow opening 28 are respectively, particularly directly, formed or delimited by a preferably inherently rigid conduit element of the device 10. In the first embodiment shown in FIG. 1, for example, the conduit element is, for example, the housing 36 of the fan 32. The air delivered by means of the fan 32 can thus flow out of the housing 36 via the outflow opening 28.

The collection element 42 also described as a capture element has a further, preferably inherently rigid conduit element 49, which can be a further housing of the collection element 42. The capture opening 44 also described as an intake opening is preferably delimited, particularly directly, by the conduit element 49. At least a part of the air curtain, and thus at least a part of the droplets and/or particles removed by means of the air curtain and guided to the capture opening 44 in a targeted manner can be captured in a targeted manner by means of the capture opening 44, in particular in such a manner that at least the part of the air curtain also described as the air curtain part, and thus the particulates guided to the capture opening 44 by means of the air curtain, flow through the capture opening 44, and can thus flow into the collection element 42 via the capture opening 44, and in the process particularly into the conduit element 49. For this purpose, the particulates are transported through the capture opening 44 by means of the air curtain part, for example, and thus transported into the collection element 42 or into the conduit element 49. The particulates can thus be prevented from getting back to the person 16 or from reaching another person optionally remaining in the interior 12, such that the infection risk can be kept particularly low.

It can be seen that the capture opening 44 is located opposite the outflow opening 28 in the transverse direction of the vehicle, as the previously specified forced flow runs in the outward transverse direction of the vehicle in the exemplary embodiment shown in FIG. 1. In other words, the particulates expelled with the breathing air are delivered away from the mouth and nose region 22 or from the region arranged in front of it via the forced flow and delivered to the collection element 42, and are delivered through the capture element 44 in the process.

In the first embodiment, the collection element 42 has a further fan 50 provided in addition to the fan 32 and in addition to the main fan of the motor vehicle to which the previous and following embodiments of the fan 32 can be transferred and vice versa. The fan 50 has a further fan wheel 52 that can be rotated relative to the conduit element 49, which is for example a further housing of the fan 50. The fan 50 takes in air, particularly from an environment of the capture opening 44, via rotation of the fan wheel 52 occurring relative to the conduit element 49. The fan 50 can be formed as an electric fan, and thus have a further electric motor, by means of which the fan wheel 52 can be driven and can thus be rotated relative to the conduit element 49. By means of the further fan 50, particularly by means of the further fan wheel 52, at least the previously described air curtain part, and thus at least the particulates delivered by means of the air curtain part, can be taken into the capture opening 44, and can thus be delivered through the capture opening 44 and hereby taken or delivered into the collection element 42 via the capture opening 44. The air curtain part taken into the collection element 42 via the capture opening 44, and thus the particulates, can be delivered through the collection element 42 (capture element), and in the process particularly through the conduit element 49 by means of the further fan 50, for example. In other words, the fan 50 can take in the particulates arriving at the collection element 42 with the forced flow embodied as a transverse flow and take them in via the capture opening 44, and remove them from the interior 12, for example.

In the first embodiment, the collection element 42 has a filter element 54, by means of which the air curtain part or the air forming the air curtain part that flows into the collection element 42 via the capture opening 44 and flows through the collection element 42, for example, can be filtered, particularly in such a manner that the particulates received in the air forming the air curtain part and taken into the collection element 42 and thus captured via the capture opening 44 are filtered out of the air forming the air curtain part by means of the filter element 54, i.e., separated. For this purpose, the filter element 54 is, for example, formed so as to retain droplets and/or particles having a diameter of less than five micrometers, and thus to filter them out of the captured part of the air curtain. The filter element 54 is arranged downstream of the fan wheel 52, i.e., behind the fan wheel 52 in the flow direction of the air curtain flowing through the collection element 42. The air filtered by means of the filter element 54 or the air flowing through the collection element 42 can flow out of the collection element 42, and flow back into the interior 12, particularly via the filter element 54, for example, or the air flowing through the collection element 42 is released to the environment of the motor vehicle via an output opening leading to an environment of the motor vehicle, such that a direct introduction of the air flowing through the collection element 42 from the device 10 into the interior 12 ceases.

The collection surface 46 or the capture opening 44 can be part of a door cladding or be formed for example in a door cladding, by means of which, for example, a door, particularly a side door, of the motor vehicle to the interior 12 can be at least partially clad. This should particularly be understood to mean that a shell of the door to the interior 12 is clad at least partially, particularly at least predominantly or completely by means of the door cladding.

In the exemplary embodiment shown in FIG. 1, displaceable conduit elements 57 are assigned to the outflow opening 28, which are also described as air guidance elements. The conduit elements 57 can be displaced relative to the housing 36, can particularly be pivoted, such that a flow direction of the air flowing through the outflow opening 28 can be varied via movement occurring relative to the housing 36, particularly pivoting, of the preferably inherently rigid air guidance elements. In other words, a flow direction in which the air delivered by means of the fan 32 flows through the outflow opening 28, and thus out of the housing 36, can be changed or varied, i.e., adjusted, as the conduit elements 57 are moved relative to the housing 36. The air curtain or the forced flow can thus be directed in a targeted manner in the direction of the nose 26 and the mouth 24 of the passengers. The respective conduit element 57 is displaced by means of an actuator depending on a seat position of the person 16 or the seat arrangement 14, i.e., depending on a seat adjustment of the seat arrangement 14. In other words, the seat arrangement 14 has a seating element that cannot be seen in FIG. 1 on which the person 16 can sit with their buttocks or on which the person 16 sits with their buttocks. The back rest 18 can here be displaced relative to the seat element and/or the head support 20 can be displaced, i.e., moved, relative to the back rest 18 and/or relative to the seat element. The head support 20, the back rest 18 and the seat element are seat parts of the seat arrangement 14, wherein at least two of the seat parts of the seat arrangement 14 can be moved relative to each other, i.e., moved into different positions relative to each other and fixed in different positions relative to each other. The seat parts can particularly be moved relative to each other by means of a particularly electric drive. It is here preferably provided that the respective conduit element 57 is moved relative to the housing 36 by means of an actuator, particularly able to be operated electrically, particularly automatically, depending on the positions into which the seat parts are moved relative to each other, such that the respective conduit element 57 is adapted, in particular with regard to its position relative to the housing 36, particularly automatically, to the respective positions in which seat parts are moved relative to each other. It can thus be ensured that the air curtain sweeps past on or in front of the mouth and nose region 22 of the person 16, such that the particulates can be removed effectively and efficiently and in a targeted manner. In other words, the conduit element 57 is moved relative to the housing 36, particularly automatically, by means of the actuator, depending on the or a displacement of the seat parts relative to each other.

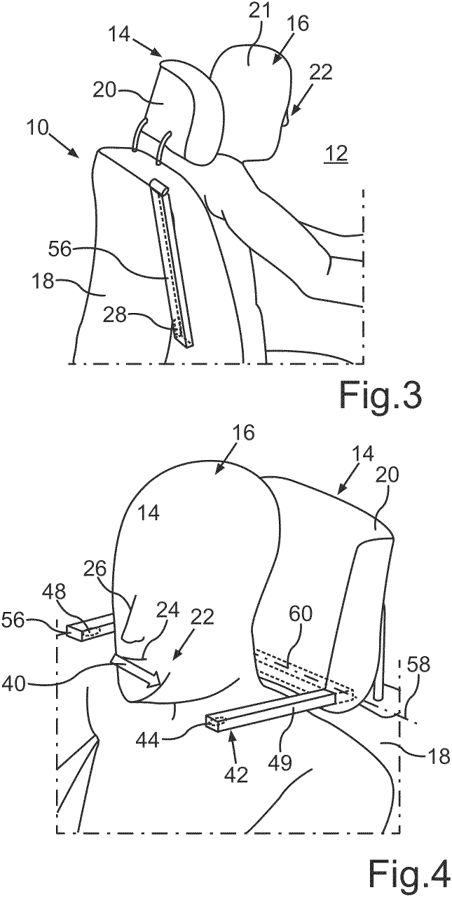

FIGS. 2 and 3 show a second embodiment of the device 10 or the motor vehicle. In the second embodiment, the outflow opening 28 is formed or delimited, particularly directly, by a preferably inherently rigid conduit element 56. The conduit element 56 is here moveably held on the seat arrangement 14, particularly on the back rest 18, particularly in such a manner that the conduit element 56, and with it the outflow opening 28, can be pivoted around a pivot axis 58 relative to the seat arrangement 14, particularly relative to the back rest 18. This means that the conduit element 56 can be pivoted around the pivot axis 58 relative to the seat arrangement 14 while the conduit element 56 is held on the seat arrangement 14. In the second embodiment, the pivot axis 58 runs at least substantially in the transverse direction of the vehicle. The conduit element 56 here respectively delimits the air channel 48 and its outflow opening 28 directly, such that the air channel 48 and the outflow opening 28 can be pivoted around the pivot axis 58 relative to the seat arrangement 14. The conduit element 56 can here be moved, particularly pivoted, between at least one usage position shown in FIG. 2 and at least or exactly one stowed position shown in FIG. 3 relative to the seat arrangement 14. The fan 32 is arranged on the seat arrangement 14, particularly in the seat arrangement 14, for example. It is here particularly conceivable that the fan 32 is arranged on and particularly in the back rest 18. The housing 36 through which the air forming the air curtain can be delivered by means of the fan 32 is fluidically connected to the air channel 48 that is arranged downstream of the housing 36, for example.

In the stowed position shown in FIG. 3, the conduit element 56 abuts at least substantially flush on the seat arrangement 14, particularly for example on the back rest 18.

The seat arrangement 14 can be moved in the interior 12 relative to a structure of the motor vehicle delimiting the interior 12, wherein the structure is preferably a self-supporting body. As, in the second embodiment, the conduit element 56 and preferably also the fan 32 are fixed relative to the seat, i.e., held on the seat arrangement 14 rather than being fixed relative to the structure, i.e., immovable relative to the structure, the conduit element 56 and the fan can be moved with the seat arrangement 14, particularly relative to the structure. If the seat arrangement 14 is moved relative to the structure, particularly in the longitudinal direction of the vehicle, for example, then the conduit element 56 and the fan are moved with the seat arrangement 14, such that the conduit element 56 and the fan 32 can be moved into different seat positions of the seat arrangement 14 relative to the structure. As an alternative or in addition, the seat arrangement 14, and with it the conduit element 56 and the fan 32 can be moved in the vertical direction of the vehicle relative to the structure. Different seat heights or different torso lengths of different seat passengers can be covered by different pivot angles of the conduit element 56, particularly relative to the back rest 18, for example. In other words, it is conceivable that the device 10 has a further actuator that can particularly be operated electrically, by means of which the conduit element 56 can be pivoted around the pivot axis 58 relative to the seat arrangement 14, particularly using electrical current. The conduit element 56 can thus be moved, particularly pivoted, into different positions relative to the seat arrangement 14, wherein it is preferably provided that the conduit element 56 can be fixed in its different positions relative to the seat arrangement 14. The conduit element 56 can thus be adapted to passengers of different sizes, particularly with regard to its pivot angle relative to the seat arrangement 14.

It can be seen from FIGS. 2 and 3 that the collection element, and thus the capture opening, are not required in the second embodiment. The outflow opening 28 is arranged in the interior 12 of the motor vehicle in the first and second embodiment.

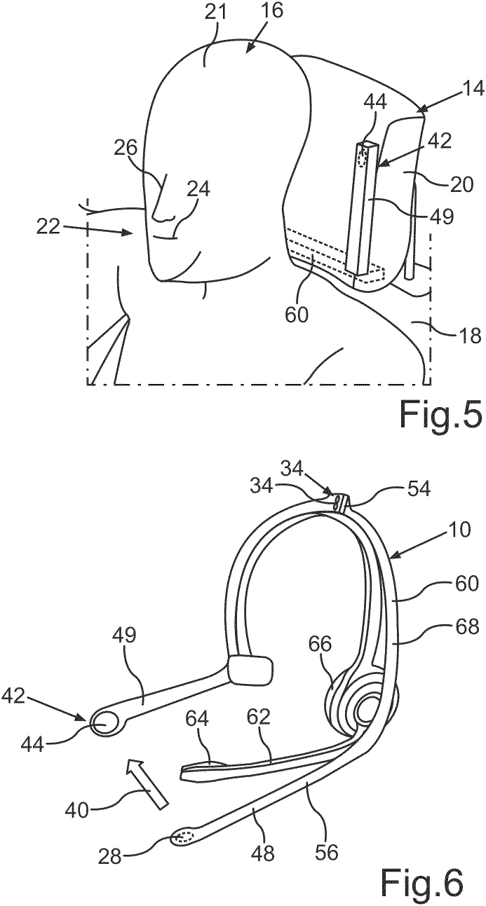

FIGS. 4 and 5 show a third embodiment of the device 10 or of the motor vehicle. The third exemplary embodiment is particularly a combination of the first embodiment and the second embodiment, for example, as the outflow opening 28 and the collection element 42 are provided with the capture opening 44 in the third embodiment. Unlike in the second embodiment, the conduit element is moveably, particularly pivotably, held not on the back rest 18 but on the head support 20. The previous and following embodiments of the conduit element 56 and the outflow opening 28 can here also be easily applied to the conduit element 49 and the capture opening 44 and vice versa. This means, for example, that the conduit element 49, which forms the capture opening 44, particularly directly, can be moveably, particularly pivotably, held on the seat arrangement 14, and here on the head support 20, for example. The collection element 42 or the conduit element 49 and the capture opening 44 are thus moveably held on the seat arrangement 14, particularly the head support 20, in such a manner that the conduit element 49 and thus the capture opening 44 can be pivoted around a pivot axis 58 relative to the seat arrangement 14 between at least one usage position shown in FIG. 4 and at least one stowed position shown in FIG. 5. The same can be applied to the conduit element 56 having the outflow opening 28.

As already indicated for the first embodiment, the conduit element 49 can delimit a further air channel that can be flowed through by the air curtain part or by the air forming the air curtain part, which flows into the collection element 42 via the capture opening 44 and thus into the conduit element 49 and thus into the further air channel. It is conceivable that the air channel 48 and the further air channel are fluidically connected to each other via a connecting channel 60, wherein the connecting channel 60 runs at least partially, particularly at least predominantly or entirely, within the seat arrangement 14, particularly within the head support 20. As the conduit elements 56 and 49 are held on the head support 20, particularly moveably and most particularly pivotably, the outflow opening 28 and the capture opening 44 can be arranged particularly close to the mouth and nose region 22, particularly at least in the usage position of the conduit elements 56 and 49 shown in FIG. 4. The fan 32, which can be an air delivery unit, is here arranged or housed in the head support 20, for example. The fan 32 feeds the air forming the air curtain through the air channel 48, and thus through the conduit element 56, and consequently through the outflow opening 28, whereby the forced flow or the air curtain is formed. The same fan, which delivers the air through the air channel 48, and in the process through the outflow opening 28, takes in at least the air curtain part or at least the air forming the air curtain part via the capture opening 44 opposite the outflow opening 28, particularly in the transverse direction of the vehicle, and into the further air channel and through the further air channel, such that the particulates are taken into the collection element 42 via the capture opening 44 by means of the same fan by means of which the air is delivered through the outflow opening 28. The fan consequently delivers the particulates through the further air channel, and thus through the conduit element 49. The filter element 54 is arranged in the connecting channel 60 also described as a transverse air channel, for example, by means of which filter element the particulates can be filtered out of the further air channel, and then the air flowing through the connecting channel 60 can be filtered out. It can thus be seen that a circuit is closed via the air channel 48, the further air channel and the connecting channel 60, in which or via which the air delivered by means of the fan 32 can circulate.

It is also easily conceivable, however, that the connecting channel 60 is omitted. In this case, the air flowing through the capture opening 44 and thus flowing via the capture opening 44 into the further air channel and the air flowing through the further air channel, and thus the particulates flowing through the capture opening 44, flowing into the further air channel via the capture opening 44 and flowing through the further air channel, particularly on an end of the further air channel, are separated, for example, and new air is delivered to the further air channel, and thus to the conduit element 49 by means of the fan 32 and/or by means of the further fan 50, particularly being naturally aspirated. It is thus conceivable that the air curtain part, and thus the particulates, are taken into the further air channel via the capture opening 44, and thus into the conduit element 49, and delivered through the conduit element 49 by means of the fan 50 provided in addition to the fan 32.

As already indicated, the conduit elements 56 and 49 can be moveably, particularly pivotably, held on the seat arrangement 14, particularly on the head support 20, or the conduit elements 56 and 49 are immovable relative to the seat arrangement 14.

FIG. 6 shows a fourth embodiment of the device 10. In the fourth embodiment, the device 10 is a constructed unit in itself that can be releasably reversibly fixed on the head 21 of the person 16 in itself, particularly in the manner of a head-mounted unit or head mic also described as a headset. The conduit elements 56 and 49 are respective brackets here, which are also described as mouth and nose brackets. The device 10 can further have a microphone 64 particularly held on a microphone bracket 62 and at least one loudspeaker 66, for example. As, for example, in the third embodiment having the connecting channel 60, at least the air curtain part or at least the air forming the air curtain part can be taken into the further air channel via the capture opening 44, and thus into the conduit element 49 by means of one and the same fan 32 by means of which the air is delivered through the air channel 48, and thus through the conduit element 56, and consequently through the outflow opening 28 in order to form the air curtain. The air channel 48 and the further air channel are fluidically connected to each other, for example, via the connecting channel 60 in which the fan 32 is arranged. The filter element 54 is arranged in the connecting channel 60, which filter element is arranged downstream of the fan wheel 34 or downstream of the fan 32. The person 16 can put a particularly inherently rigid bracket 68 delimiting at least the connecting channel 60 on their head 21, and thus releasably reversibly fix the device 10 on their head 21, for example.

It can be seen that the device 10 is a portable device in the fourth embodiment, which can also be brought with the person 16 outside of the interior 12. It is here preferably provided that the device 10 has an energy store for example formed as a battery, for storing electrical energy or electrical current, wherein the energy store can be charged with electrical energy. The fan 32, particularly its electric motor, can here be operated by means of electrical energy from the energy store. The connecting channel 60 is for example an air hose, via which the air channel 48 and the further air channel, and thus the outflow opening 28 and the capture opening 44 are fluidically connected to each other.

In embodiments in which the collection element 42 and associated infrastructure, for example the further fan 50, optionally the filter element 54 and the further air channel and thus the conduit element 49 are not required, the air flowing out of the outflow opening 28 acts like an air curtain that protects the person 16 and/or the other people from expelled particulates, particularly in such a manner that, by means of the air curtain, the particulates can be kept away from the nose 26 and the mouth 24. The person 16 themselves can be protected from particulates expelled by other people and the other people can be protected from particulates expelled by the person 16, particularly by at least partially capturing the air curtain by means of the collection element 42.

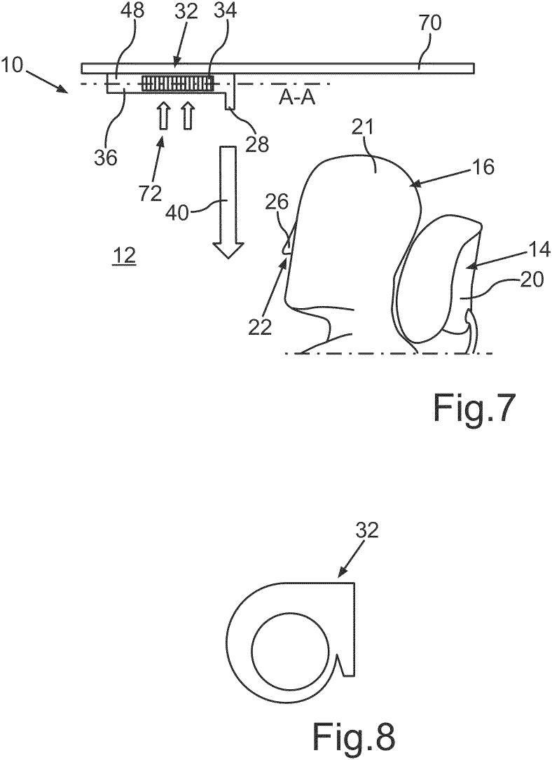

FIGS. 7 and 8 show a fifth embodiment of the device 10 or the motor vehicle. A roof liner 70 can be partially seen in FIG. 7, via which the interior 12 is at least partially delimited in the upward vertical direction of the vehicle. The roof liner 70 is a cladding element, via which, for example, a shell roof of the structure is at least partially clad in the downward vertical direction of the vehicle and thus towards the interior 12. The fan 32 is arranged on the roof liner 70 and - as depicted by arrows 72 in FIG. 7 - can take in air from the interior 12, particularly in the upward vertical direction of the vehicle. The air taken in by means of the fan 32 is delivered through the fan 32, particularly through its housing 36, and thus through the air channel 48 delimited by the housing 36 and is delivered through the outflow opening 28 while forming the air curtain - as depicted in FIG. 7 by the arrow 40 - and is thus delivered out of the housing 36 or out of the air channel 48 via the outflow opening 28. It can here be seen with reference to the arrow 40 that the air curtain or its flow direction runs in the plane stretched through the transverse direction of the vehicle and the vertical direction of the vehicle and runs from the top downward in the vertical direction of the vehicle. The air curtain streams past the mouth and nose region 22 of the person 16, and thus protects the person 16 from particles expelled by other people, for example. The fan 32 is formed, for example, as a radial fan, which takes in the air in the axial direction of the fan wheel 34 and delivers it away from the fan wheel 34 in the radial direction of the fan wheel 34. In the fifth embodiment, the air delivered and taken in by means of the fan wheel 34 comes from the interior 12.

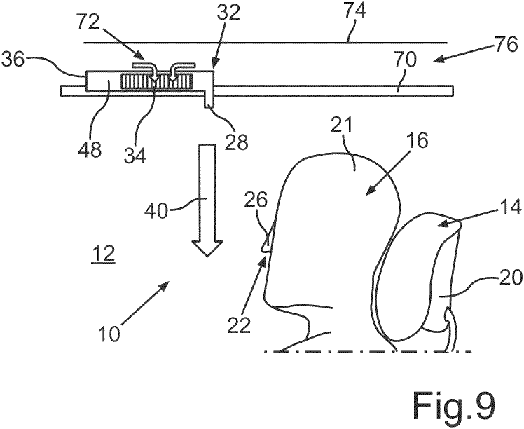

Finally, FIG. 9 shows a sixth embodiment of the device 10 or the motor vehicle. A roof element of the shell roof is labelled 74 in FIG. 9. It can be seen that the roof liner 70 is spaced apart from the roof element 74 in the vertical direction of the vehicle in such a way that a clearance 76 is arranged between the roof liner 70 and the roof element 74 in the vertical direction of the vehicle. The fan 32 is arranged at least partially, particularly at least predominantly or completely in the clearance 76 arranged through the roof element 74 in the upward vertical direction of the vehicle, particularly directly, and through the roof liner 70 in the downward vertical direction of the vehicle, particularly directly. It can be seen that the fan 32 or the fan wheel 34 does not take in air directly from the interior 12, but from the clearance 76, delivers it through the housing 36 and delivers it through the outflow opening 28. The air channel 48 leads into the interior 12 via the outflow opening 28, particularly directly, such that the air flowing through the outflow opening 28, and thus via the outflow opening 28 out of the air channel 48 - as depicted in FIG. 9 by the arrow 40 - forms the air curtain. In the sixth embodiment, the air delivered by means of the fan 32 is thus taken in outside the actual interior 12 and thereby in a region between the roof element 74 and the roof liner 70 functioning as a roof cladding. The outflow opening is for example a small air slit, via which the fan 32 blows the air delivered by means of the fan 32 out of the housing 36. This creates an air flow directed in the downward vertical direction of the vehicle in a first approximation and that functions as the air curtain in front of the nose 26 and mouth 24 of the person 16 and consequently protects the person 16 from breathing in droplets and/or particles that have been expelled via the breathing air of other people remaining in the interior 12.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A device for removing droplets or particles in a targeted manner, the device comprising:
at least one outflow opening; and
at least one fan configured to deliver air through the at least one outflow opening to form an air curtain in front of a mouth and nose region of a person that removes droplets or particles in front of the mouth and the nose region of the person; and
at least one collection element having at least one capture opening opposite the at least one outflow opening, wherein the at least one capture opening is configured to capture in a targeted manner at least part of the air curtain, which runs in a plane stretched through a transverse and vertical direction of a motor vehicle, and at least part of the droplets or particles in front of the mouth and the nose region of the person.

12. The device of claim 11, wherein the at least one collection element has a further fan, which is configured to deliver at least part of the air curtain, and at least part of droplets or particles in front of the mouth and the nose region of the person, to the at least one capture opening.

13. The device of claim 11, wherein the at least one collection element has a filter element configured to filter at least the part of the air curtain captured by the at least one capture opening.

14. The device of claim 13, wherein the filter element is configured to retain droplets or particles having a diameter of less than five micrometers and filter the droplets or particles having a diameter of less than five micrometers from a captured part of the air curtain.

15. The device of claim 11, wherein
the at least one outflow opening is formed by a conduit element,
the device has at least one air guidance element that is pivotable relative to the conduit element to vary a flow direction of the air flowing through the at least one outflow opening.

16. The device of claim 11, wherein the at least one outflow opening and the at least one capture opening are arranged in an interior of a motor vehicle.

17. The device of claim 16, wherein the at least one outflow opening or the at least one capture opening is arranged on a seat arrangement arranged in the interior of the motor vehicle or on a roof liner at least partially delimiting the interior upwards in a vertical direction of the vehicle.

18. The device of claim 11, wherein the device is a constructed unit in itself, which is releasably reversibly fixed on a head of the person.

19. A motor vehicle, comprising:
an interior;
at least one seat for one person arranged in the interior of the motor vehicle; and
at least one device for removing droplets or particles in a targeted manner, the at least one device comprising
at least one outflow opening; and
at least one fan configured to deliver air through the at least one outflow opening to form an air curtain in front of a mouth and nose region of the person that removes droplets or particles in front of the mouth and the nose region of the person; and
at least one collection element having at least one capture opening opposite the at least one outflow opening, wherein the at least one capture opening is configured to capture in a targeted manner at least part of the air curtain, which runs in a plane stretched through a transverse and vertical direction of a motor vehicle, and at least part of the droplets or particles in front of the mouth and the nose region of the person.

20. A method, comprising:
forming an air curtain in front of a mouth and nose region of a person that removes droplets or particles in front of the mouth and the nose region of the person by at least one fan delivering air through at least one outflow opening;
capturing in a targeted manner, via at least one capture opening of at least one collection element, at least part of the air curtain, which runs in a plane stretched through a transverse and vertical direction of a motor vehicle, and at least part of the droplets or particles in front of the mouth and the nose region of the person.
